(19) United States
(12) Patent Application Publication
(10) Pub. No.: US 2017/0263290 A1
(43) Pub. Date: Sep. 14, 2017

(54) DISK DRIVE

(71) Applicant: Kabushiki Kaisha Toshiba, Tokyo (JP)

(72) Inventor: Manabu Uehara, Yokohama (JP)

(21) Appl. No.: 15/454,241

(22) Filed: Mar. 9, 2017

Related U.S. Application Data
(60) Provisional application No. 62/306,971, filed on Mar. 11, 2016.

(51) Int. Cl. G11B 33/14; G11B 33/02; G11B 5/012

(52) U.S. Cl. CPC G11B 33/1466; G11B 5/012; G11B 33/027

(57) ABSTRACT

According to one embodiment, a disk drive includes a base including a bottom wall and a side wall, a cover including a top plate screwed on the side wall, a side plate provided along a peripheral edge of the top plate and opposing to an outer surface of the side wall, and an opening formed in the side plate, a sealing member held between the top plate of the cover and an upper end face of the side wall, and a recording medium rotatably provided at the bottom wall. The side wall of the base includes a first portion located adjacent to the recording medium, and a projecting portion projecting from the first portion outward of the side wall and located in the opening of the side plate.

### CROSS-REFERENCE TO RELATED APPLICATIONS

This application claims the benefit of U.S. Provisional Application No. 62/306,971, filed Mar. 11, 2016, the entire contents of which are incorporated herein by reference.

### FIELD

Embodiments described herein relate generally to a disk drive.

### BACKGROUND

A hard disk drive (HDD) functioning as a disk drive includes a rectangular housing, a recording medium (magnetic disk) formed discoid and provided in the housing, and a magnetic head which reads/writes data from/to the recording medium. The housing includes a rectangular base, a top cover formed in the shape of a plate and screwed on the base, and a packing member (gasket) provided between a peripheral edge portion of the base and the top cover.

In such an HDD, part of a side wall of the base, which is adjacent to the magnetic disk, is made to have a smaller wall thickness under constraints of dimensions. In an HDD for a device having a large height, a side wall with smaller thickness has a large height. Thus, in the case where a base having such a side wall is subjected to die-cast molding using aluminum or the like, it is disadvantage in view of fluidity of molding material. Also, part having a small wall thickness is not easily made to ensure a sufficient width of a surface to be in contact with a gasket. This easily causes a disadvantage in retention of air-tightness of the housing.

### BRIEF DESCRIPTION OF THE DRAWINGS

FIG. 1 is a perspective view showing a hard disk drive (HDD) according to a first embodiment.

FIG. 2 is an exploded perspective view of the HDD.

FIG. 3A is a perspective view showing an inside surface of a top cover of the HDD.

FIG. 3B is an exploded perspective view showing the top cover and a gasket.

FIG. 4 is a cross-sectional view of the HDD which is taken along line A-A in FIG. 1.

FIG. 5 is a cross-sectional view of the HDD which is taken along line B-B in FIG. 1.

FIG. 6 is a plan view showing an inner structure of the HDD.

FIG. 7 is an enlarged perspective view showing a notch formed in the top cover.

FIG. 8 is a plan view showing a projecting portion of a base of the HDD.

FIG. 9 is an enlarged perspective view showing a part of the housing of the HDD.

FIG. 10 is a view showing a relationship between the length of the notch and a compression ratio of packing by the top cover.

FIG. 11 is a perspective view showing an HDD according to a second embodiment.

FIG. 12 is an exploded perspective view of the HDD.

FIG. 13 is a perspective view showing an HDD according to a third embodiment.

FIG. 14 is an exploded perspective view of the HDD.

### DETAILED DESCRIPTION

Various embodiments will be described hereinafter with reference to the accompanying drawings. In general, according to one embodiment, a disk drive comprises a base comprising a bottom wall and a side wall provided along a peripheral edge portion of the bottom wall, a cover comprising a top plate screwed on the side wall, a side plate provided along a peripheral edge of the top plate and opposing to an outer surface of the side wall, and an opening formed in the side plate; a sealing member held between the top plate of the cover and an upper end face of the side wall; and a recording medium rotatably provided at the bottom wall. The side wall of the base comprises a first portion located adjacent to the recording medium, and a projecting portion projecting from the first portion outward of the side wall and located in the opening of the side plate.

### First Embodiment

A hard disk drive (HDD) according to a first embodiment will be explained as a disk drive in detail.

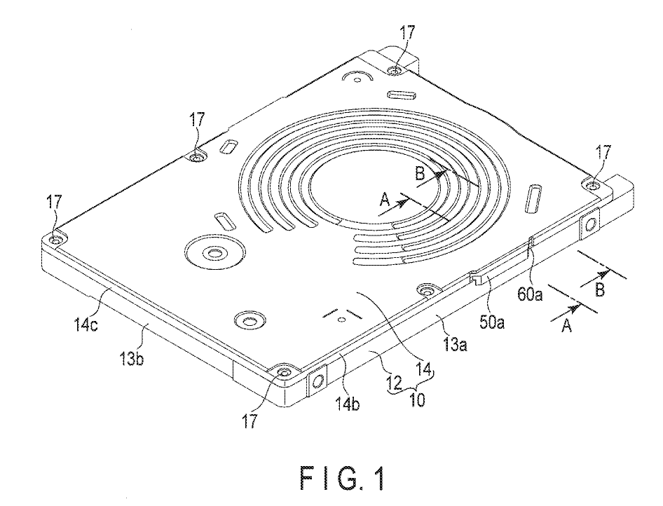

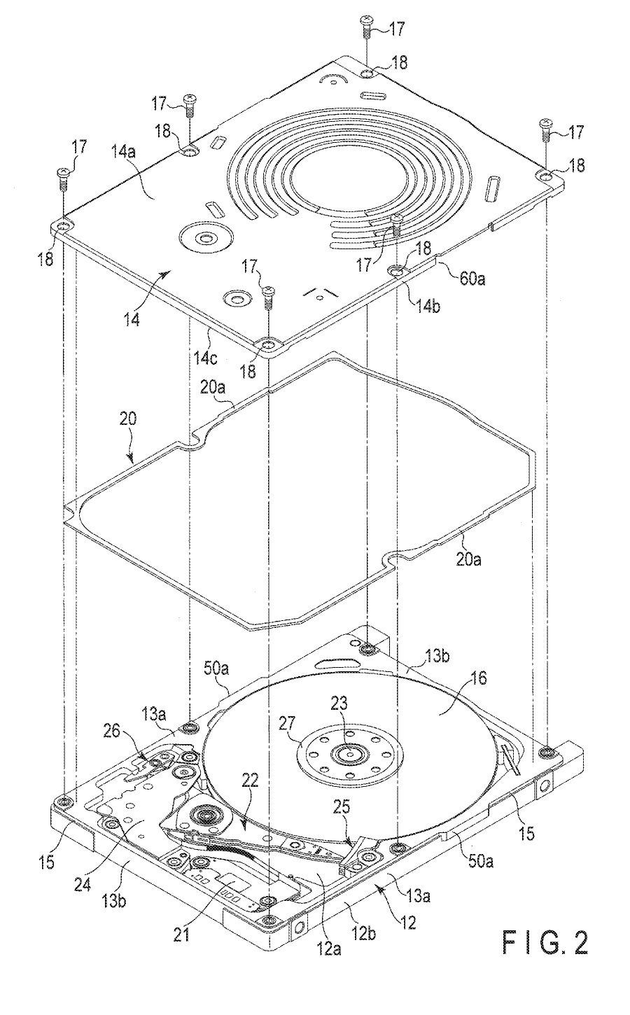

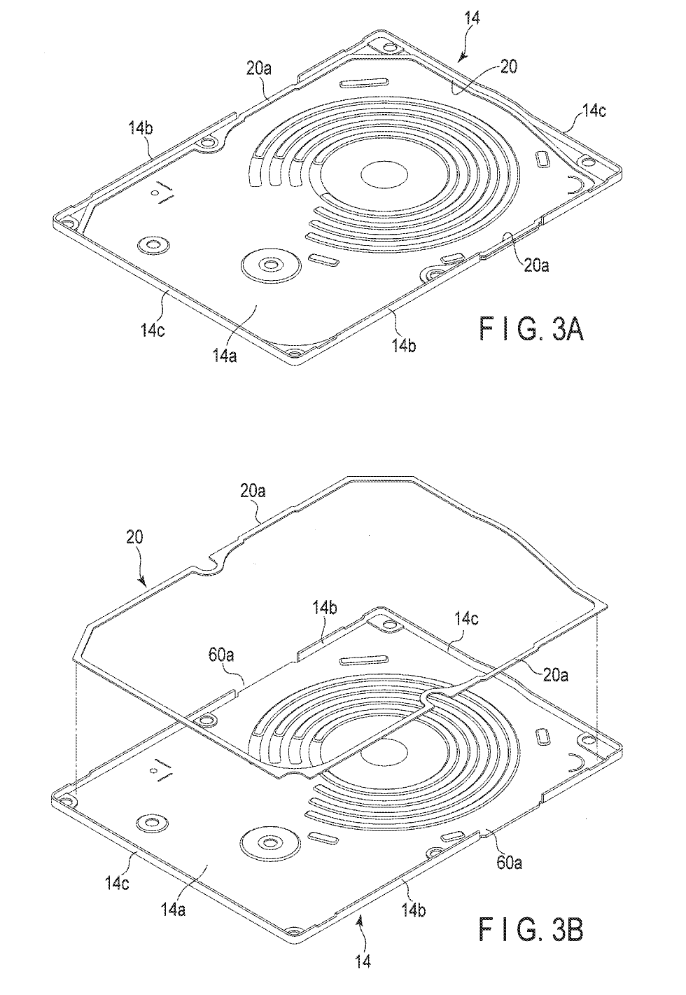

FIG. 1 is a perspective view showing the HDD according to the first embodiment; FIG. 2 is an exploded perspective view of the HDD; and FIG. 3 is a plan view showing an inner structure of the HDD.

With respect to the first embodiment, a 2.5-inch HDD incorporating a magnetic disk having a diameter of approximately 2.5 inches (63.5 mm) will be described by way of example. As shown in FIGS. 1 and 2, the HDD comprises a flat and rectangular housing 10. The housing 10 comprises a base 12 formed in the shape of a rectangular box with an opened top, and a rectangular top cover 14. The top cover 14 is secured to the base by a plurality of screws 17 to close the opened top of the base 12.

The base 12 includes a rectangular bottom wall 12a and a side wall 12b provided along a peripheral edge of the bottom wall 12a, and the base 12 is integrally formed of a metallic material such as aluminum, stainless steel, and the like. The base 12 includes a longitudinal direction and a width direction perpendicular to the longitudinal direction. The side wall 12b of the base 12 includes a pair of long side walls 13a extending in the longitudinal direction and located opposite to each other, and a pair of short side wails 13b extending in the width direction and located opposite to each other. In the entire outer surface of an upper end portion of the side wall 12b, a reception groove 15 is formed.

The top cover 14 is formed in the shape of a rectangular lid which has substantially the same size as the bottom wall 12a of the base 12, by press-forming, for example, a SUS plate having a thickness of 45 mm. The top cover 14 comprises a rectangular top plate 14a, a pair of short side plates 14c and a pair of long side plates 14b which are formed by bending side edge portions of the top plate 14a toward the base 12 at substantially a right angle. The height of each of the side plates is set half or less than that of the side wall 12b of the base 12.

Through holes 18 are formed in four corner portions of the top plate 14a and in positions which are slightly displaced from the centers of side edges of a pair of long sides toward one of the short side walls 13b. The top cover 14 is secured to the side wall 12b of the base 12 by screwing the screws 17, which are inserted in the through holes 18, into threaded holes formed in the side wall 12b of the base 12. That is, the top cover 14 is secured to the base 12 by the screws 17 at both end portions of the short side walls 13b in the longitudinal directions thereof and at substantially central portions of the long side walls 13a in the longitudinal directions thereof. The long side plates 14b and short side plates 14c of the top cover 14 are located in the reception groove 15 of the side wall 12b.

FIG. 3A is a perspective view showing an inner surface side of the top cover 14, and FIG. 3B is a exploded perspective view showing the top cover 14 and a gasket (packing material).

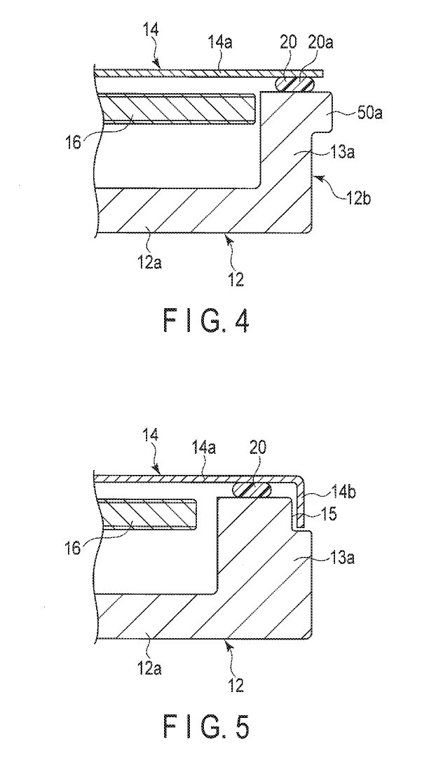

As shown in FIGS. 2, 3A and 3B, a gasket (packing material or sealing member) 29 formed in the shape of a frame is interposed between an upper end face of the side wall 12b of the base 12 and an inner surface of the top cover 14. The gasket 20 is formed of, for example, synthetic resin. The gasket 20 is adhered to or coated on the inner surface of the top cover 14. The height (thickness) of the gasket 20 is set larger than a gap between the top cover 14 and the base 12. FIG. 4 is a cross-sectional view of the HDD which is taken along line A-A in FIG. 1; and FIG. 5 is a cross-sectional view of the HDD which is taken along line B-B in FIG. 1. As shown in FIGS. 4 and 5, when the top cover 14 is screwed on the base 12, the gasket 20 is held and compressed between the top cover 14 and the side wall 12b of the base 12 to hold the airtightness of the inside of the housing 10.

FIG. 5 is a plan view showing an inner structure of the HDD. As shown in FIGS. 2 and 5, in the housing 10, as a recording medium, for example, a magnetic disk 16 and a spindle motor 23 are provided, the spindle motor 23 functioning as a driving unit which supports and rotates the magnetic disk 16. The spindle motor 23 is provided on the bottom wall 12a. The magnetic disk 16 has, for example, a diameter of approximately 2.5 inches (63.5 mm), and includes magnetic recording layers (magnetic recording surfaces) on its both surfaces (upper and lower surfaces), respectively. It should be noted that the 2.5-inch magnetic disk is not limited to a magnetic disk having a diameter of 63.5 mm, and covers a magnetic disk having a diameter of 65 mm or more. The magnetic disk 16 is engaged coaxially with a hub not shown of the spindle motor 23, and clamped by a clamp spring 27 to be fixed to the hub. Thereby, the magnetic disk 16 is supported in parallel with the bottom wall 12a of the base 12. The magnetic disk 16 is rotated at a predetermined speed by the spindle motor 23. Also, within the housing 10, the magnetic disk 16 is displaced from a center portion of the base 12 in the longitudinal direction of the base 12, toward one of the short side walls 13b. Thereby, the magnetic disk 16 is located adjacent to the above one of the short side walls 13b, and separated from the other of the short side wails 13b.

In the housing 10, a plurality of magnetic heads 19 and a carriage assembly 22 are provided. The magnetic heads 17 read/write data from/to the magnetic disk 16, and the carriage assembly 22 supports the magnetic heads 17 to be movable relative to the magnetic disk 16. Furthermore, in the housing 10, a voice coil motor (VCM) 24, a ramp load mechanism 25, a latch mechanism 26 and a flexible printed circuit board (FPC) unit 21 are provided. The VCM 24 rotates and positions the carriage assembly 22. The ramp load mechanism 25 holds the magnetic heads 19 in an unload position separated from the magnetic disks 16, when the magnetic heads 19 are moved to an outermost circumferential portion of the magnetic disk 16. The latch mechanism 26 holds the carriage assembly 22 in a retreat position when an impact or the like is applied to the HDD. On the FPC unit 21, electronic components such as a conversion connector are mounted. The carriage assembly 22, the VCM 24, the ramp load mechanism 25, the latch mechanism 26 and the FPC unit 21 are provided in a space between the magnetic disk 16 and the above other of the short side walls 13b in the base 12.

According to the first embodiment, at least one of the long side walls 13a of the base 12 of the housing 10, i.e., both the long side walls 13a in this case, each includes a first portion located adjacent to an outer circumferential edge of the magnetic disk 16, and a projecting portion 50a which projects or is expanded from the first portion and located outward of the side wall 13a. The first portion and the projecting portion 50a are formed integral with each other. The long side plates 14b of the top cover 14 include notches or openings 60a in which the projecting portions 50a are to be located.

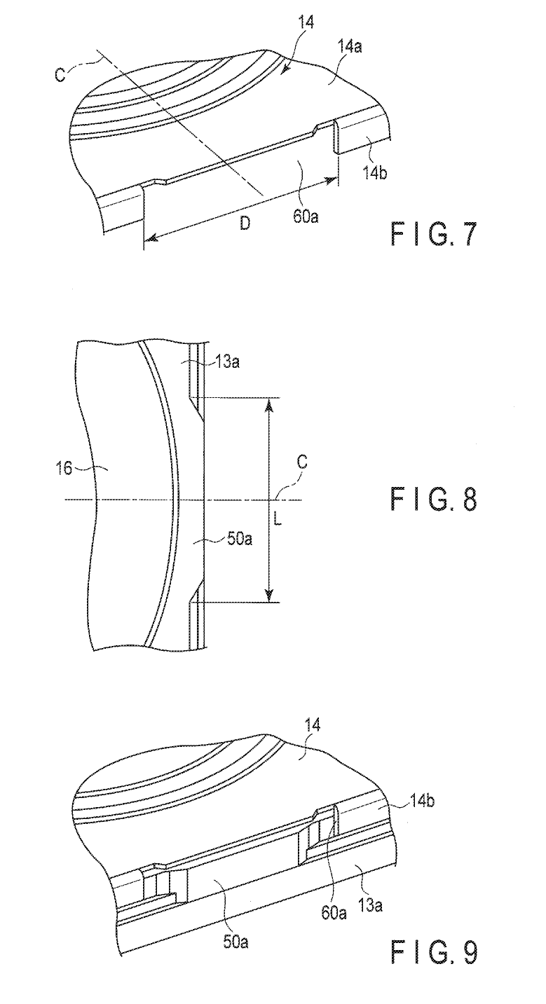

FIG. 7 is a perspective view showing the opening 60a of the top cover 14; FIG. 8 is a plan view showing a projecting portion 50a of the base 12, and FIG. 9 is a perspective view showing the projecting portion 50a and the opening 60a. As shown in FIGS. 1, 2, 6 and 8, each of the long side walls 13a of the base 12 includes the first portion located adjacent to the outer circumferential edge of the magnetic disk 16, and the projecting portion 50a, which is provided at the first portion and integral with each other. It should be noted that with respect to the first embodiment, the above “located adjacent to” means being located opposite to the outer circumferential edge of the magnetic disk 16, with a small gap of approximately 1 mm interposed between them. The projecting portion 50a projects or is expanded outwardly from the outer surface of the long side wall 13a. In the height direction of the long side wail 13a, the projecting portion 50a is provided on an upper end side of the long side wall 13a, and is formed flush with the upper end face of the long side wall 13a. The projecting portion 50a is formed to have a thickness which is greater than the thickness of the long side plate 14b of the top cover 14, and half or less than the height of the long side wall 13a. To be more specific, two projecting portions 50a are located in locations crossing straight line C which extends through the center of the magnetic disk 16 and parallel to the short side walls 13b of the base 12. In the first embodiment, the projecting portions 50a are formed on both sides of straight line C and extend equidistantly with respect to straight line C. The length L of the projecting portion 50a in the longitudinal direction of the long side wall 13a is set to, for example, approximately 16 mm.

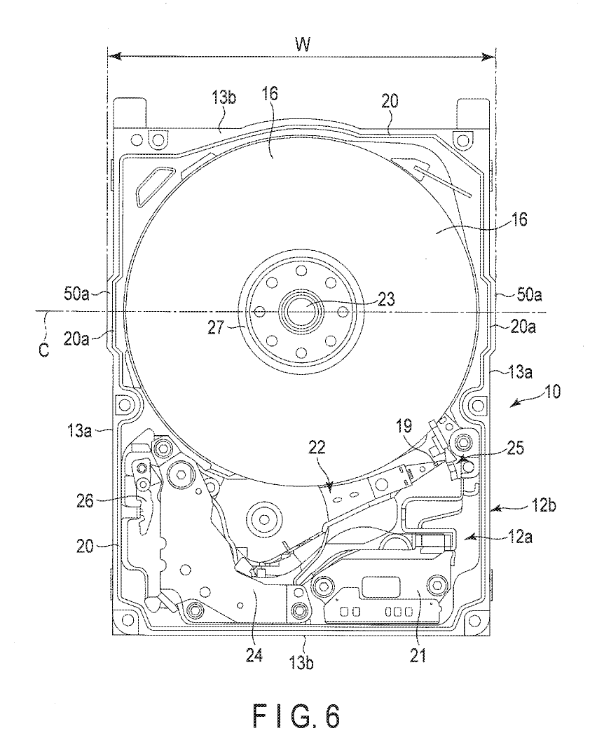

The expansion amount (projection length) of each projecting portion 50a is set such that each projecting portion 50a extends more outwardly than the long side edge of the top plate 14a of the top cover 14, and width W, which is the distance between the two projecting portions 50a (the width of the widest part of the base 12 (see FIG. 6), is set greater than the width of the top cover 14. However, width W is set to fall within a range of the width which accords to external dimension standards of HDDs (for example, SFF standards). In a 2.5-inch HDD, since it is set that W=69.85±0.25 mm, width W of the base 12 is set to 70.1 mm or less.

As described above, by virtue of provision of the projecting portions 50a, upper end faces of portions of the long side walls 13a, which correspond to the projecting portions 50a, can be made to have greater widths (they can be made thicker), and their widths can thus be equal to or greater than those of other portions of the long side walls 13a.

As shown in FIGS. 2 and 4, the gasket 20 includes bent portions 20a in positions corresponding to those of the projecting portions 50a of the long side walls 13a, the bent portions 20a being bendable and extendable outwardly in accordance with the projecting portions 50a. Thereby, also at the projecting portions 50a of the side wall 12b, the gasket 20 contacts center portions of the upper end face of the side wall 12b, which are located at the centers in the width direction thereof.

On the other hand, as shown in FIGS. 2, 3A, 3B and 5, the notches or openings 60a formed in the long side plates 14b of the top cover 14 are disposed in positions corresponding to those of the two projecting portions 50a. To be more specific, two notches or openings 60a are provided in locations crossing straight line C which extends through the center of the magnetic disk 16 and parallel to the short side walls 13b of the base 12. The notches or the openings 60a are formed on both sides of straight line C and extend equidistantly with respect to straight line C. Lengths (widths) D of the openings 60a in the longitudinal directions of the long side walls 13a are set to 20 mm or less (D≦20 mm), for example, 16 mm, and the heights of the openings 60a are the same as those of the long side plates 14b.

As shown in FIGS. 1 and 9, when the top cover 14 is screwed on the side wall 12b of the base 12, the projecting portions 50a of the base 12 are located in the openings 60a of the long side plates 14b of the top cover 14, and extend more outwardly than the long side plates 14b through the openings 60a. Also, as shown in FIGS. 4 and 5, at the projecting portions 50a, the gasket 20 is held and compressed between the top plate 14a of the top cover 14 and the upper end face of the side wall 12b to hold the airtightness at the projecting portions 50a.

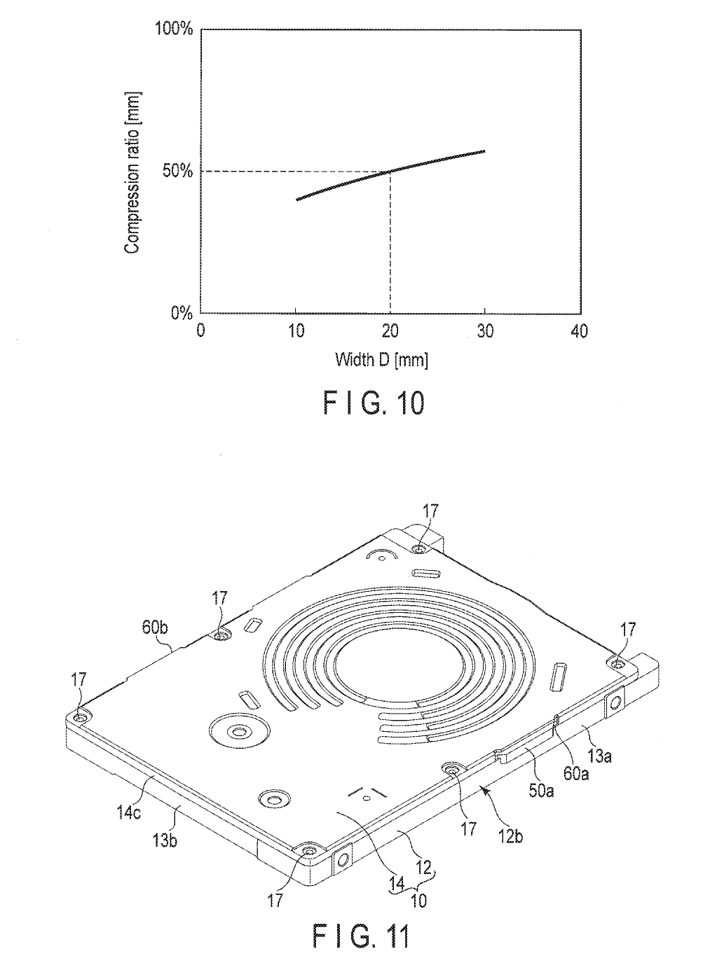

In the HDD comprising the above structure, the greater the lengths (widths) D of the notches or openings 60a of the top cover 14, the lower the stiffness of the top cover 14, as a result of which the top cover 14 can be more easily swollen by a reaction force generated when the gasket 20 is compressed. Thus, a substantial gasket compression rate is lowered. FIG. 10 shows a result obtained by a structural simulation made with respect to a relationship between the ratio of deformation (compression ratio) of the top cover with respect to a gasket collapse amount and widths D of the openings 60a. It can be seen from FIG. 10 that when widths D of the openings 60a exceed 20 mm, an actual compression amount of the gasket becomes half or less than a predetermined compression amount of the gasket, thus losing the airtightness achieved by the gasket. Therefore, it is preferable that lengths (widths) D of the openings 60a of the top cover 14 be set to satisfy “D≦20 mm”. According to the first embodiment, as described above, D=16 mm. Furthermore, in accordance with the openings 60a, the width of the base 12 is increased within a range of the width which accords to the external dimension standards of 2.5-inch HDDs.

In the HDD having the above structure, the projecting portions 50a are provided in thick and thin wall portions of the side wall 12b of the base 12, the widths of the thick and thin wall portions can be increased to the maximum under constraints regarding external dimensions of the device, and the thicknesses of the side walls can be increased. Furthermore, it is possible to reduce a dimension tolerance by performing cutting processing to form the projecting portions 50. It is therefore expected that the wide walls will be made to have a greater thickness. By increasing the thicknesses of the side walls, the casting performance of the base 12 can be improved. Furthermore, the widths of surfaces of the side walls (upper end faces of the side walls 12b), which are to be in contact with the gasket 20, are increased, and thus the airtightness of the housing 10 can thus be improved. Furthermore, in the first embodiment, three screw holes are formed in each of the long side walls 13a of the base 12, and with respect to the screw holes, the distances between a center screw hole and screw holes formed at the both end portions in the longitudinal direction of the long side walls are set such that the distance between two of the screw holes which are provided on a magnetic disk side on which the magnetic disk 16 is located is greater than that between two of the screw holes which are provided on a carriage assembly side on which the carriage assembly 22 is located. Furthermore, the projecting portion 20a of each long side wall 13a is provided between the screw holes which are separated from each other by the above greater distance, thus improving the aritightness at a region between those screw holes.

By virtue of the above, according to the first embodiment, it is possible to obtain a disk drive whose casting performance is high and whose airtightness is improved.

Next, HDDs according to some other embodiments will he explained. It should be noted that, in other embodiments to be described below, portions like those of the above-described first embodiment are denoted by the same reference numbers and their detailed explanations will be omitted or simplified, and portions different from those of the first embodiment will be mainly explained in detail.

### Second Embodiment

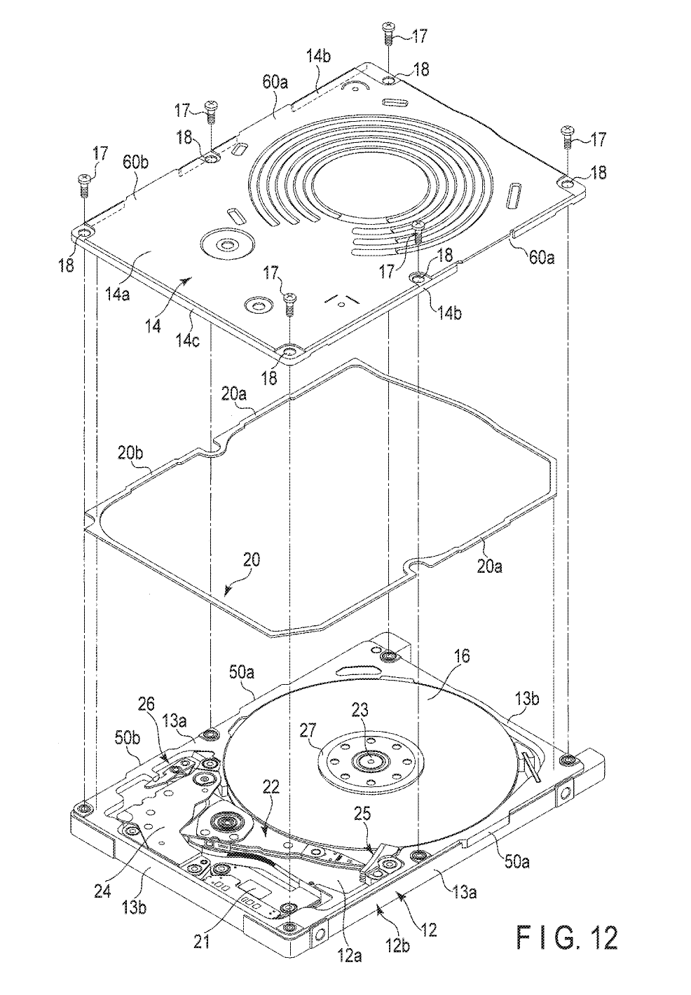

FIG. 11 is a perspective view showing an HDD according to a second embodiment, and FIG. 12 is a perspective exploded view of the HDD.

As shown in FIGS. 11 and 12, in the second embodiment, a long side wall 13a of a base 12 included in a housing 10 comprises a side-wall portion (second portion) located adjacent to a latch mechanism 26, and a second projecting portion 50b projecting or expanding outwardly from the side-wall portion and located outward of the long side wall 13a. The side-wall portion and the second projecting portion 50b are formed integral with each other. The second projecting portion 50b has the same structure as the projecting portion 50a. Furthermore, a notch or a second opening 60b is formed in a long side plate 14b of a top cover 14, and the second projecting portion 50b is located in the notch or the second opening 60b. The shape and size of the second opening 60b is the same as those of the above openings 60a. Furthermore, a gasket 20 includes a second bent portion 20b in a position corresponding to that of the projecting portion 50b of the long side wall 13a, the second bent portion 20b being bended outwardly along the second projecting portion 50b. Thereby, also at the second projecting portion 50b of the side wall 12b, the gasket 20 contacts a center portion of an upper end face of the side wall 12b, which is located at the center in the width direction thereof.

The other structural features of the HDD are the same as those of the HDD according to the first embodiment.

Also, in the second embodiment having the above structure, the second projecting portion 50b is provided in part of the long side wall 13b, which is located close to the latch mechanism 26, as a result of which this part can be made to have a greater thickness, and a base side wall can be widened within a range according to external dimension standards of devices. It is therefore possible to improve the casing performance of the base 12. Furthermore, the width of a surface of the base 12 (upper end faces of side walls) which is to be in contact with the gasket 20 is increased, thereby improving the airtightness of the housing.

### Third Embodiment

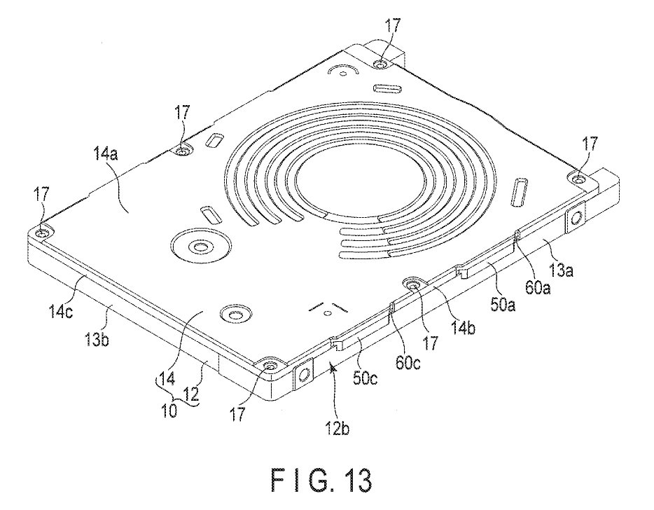

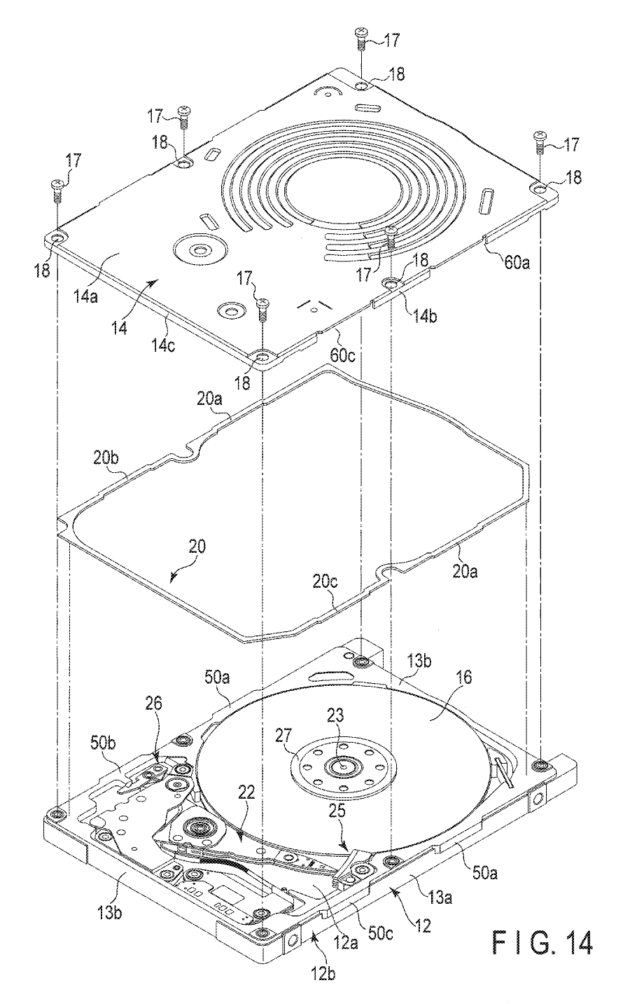

FIG. 13 is a perspective view showing an HDD according to a third embodiment, and FIG. 14 is an exploded perspective view of the HDD.

As shown in FIGS, 13 and 14, in the third embodiment, a long side wall 13a of a base 12 instituting a housing 10 comprises a side-wall portion (third portion) located adjacent to a ramp of a ramp mechanism 25, and a third projecting portion 50c projecting or expanding from the side-wall portion and located outward of the long side wall 13a. The third projecting portion 50c has the same structure as the projecting portion 50a. A notch or a third opening 60c in which the third projecting portion 50c is to be located is formed in a long side plate 14b of a top cover 14. The shape and size of the third opening 60c is the same as those of the above openings 60a. Furthermore, a gasket 20 includes a third bent portion 20c in a position corresponding to that of the projecting portion 50c of the long side wall 13a, the third bent portion 20c being bended outwardly along the third projecting portion 50c. Thereby, at the third projecting portion 50c of the side wall 12b, the gasket 20 contacts with a center portion of an upper end face of the side wall 12b in the width direction of the upper end face.

The other structural features of the HDD are the same as those of the HDD according to the first embodiment.

According to the third embodiment having the above structure, the third projecting portion 50c is provided in part of the long side wall 13b, which is located close to the ramp mechanism 25, as a result of which this part can be made to have a greater thickness, and a base side wall can be widened within a range according to external dimension standards of devices. It is therefore possible to improve the casing performance of the base 12. The width of a surface of the base 12 (upper end faces of side walls) which is to be in contact with the gasket 20 is increased, thereby improving the airtightness of the housing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the above first embodiment, the projecting portions of the base are provided at a pair of long side walls. However, the structure of the projecting portions is not limited to such a structure, and a projecting portion may be provided at only one of the long side walls. In this case also, the casting performance and the airtightness can be improved. Also, in each of the second and third embodiments, as the projecting portion thereof, only the second projecting portion or third projecting portion may be provided.

The number of magnetic disks is not limited to one, and may be set to two ore more, and the number of magnetic heads may also be varied in accordance with the number of magnetic disks provided. The size of the magnetic disk is not limited to 2.5 inches; that is, a magnetic disk having another size may be used. The materials, shapes, sizes, etc. of elements forming the disk drive are not limited to those disclosed with respect to the above embodiments, and can be variously changed as occasion needed.

What is claimed is:

1. A disk drive comprising:
a base comprising a bottom wall and a side wall provided along a peripheral edge portion of the bottom wall,
a cover comprising a top plate screwed on the side wall, a side plate provided along a peripheral edge of the top plate and opposing to an outer surface of the side wall, and an opening formed in the side plate;
a sealing member held between the top plate of the cover and an upper end face of the side wall; and
a recording medium rotatably provided at the bottom wall,
wherein the side wall of the base comprises a first portion located adjacent to the recording medium, and a projecting portion projecting from the first portion outward of the side wall and located in the opening of the side plate.

2. The disk drive of claim 1, wherein the side wall of the base comprises a pair of long side wails located opposite to each other and a pair of short side walls located opposite to each other, at least one of the long side walls including the projecting portion.

3. The disk drive of claim 2, wherein each of the pair of long side walls includes the projecting portion.

4. The disk drive of claim 3, wherein the base includes a longitudinal direction and a width direction perpendicular to the longitudinal direction, the projecting portions of the pair of long side walls are provided on a straight line extending in the width direction through a center of the recording medium.

5. The disk drive of claim 4, wherein a width of the opening in a longitudinal direction of the side plate is set equal to or less than 20 mm.

6. The disk drive of claim 1, wherein the sealing member is formed in a shape of a frame extending along an upper end face of the side wall, and includes a bent portion which is bent outwardly along the projecting portion.

7. The disk drive of claim 1, which further comprises:
a head configured to magnetically read or write data from or to the recording medium;
a carriage assembly supporting the head to movable relative to the recording medium; and
a latch mechanism configured to latch the carriage assembly,
the side wall of the base comprises a second portion located adjacent to the latch mechanism, and a second projecting portion projecting outwardly from the second portion and located outward of the side wall, and
the side plate of the cover includes a second opening in which the second projecting portion is located.

8. The disk drive of claim 7, wherein a width of the second opening in a longitudinal direction of the side plate is set equal to or less than 20 mm.

9. The disk drive of claim 1, which further comprises:
a head configured to magnetically read or write data from or to the recording medium; and
a ramp load mechanism configured to hold the head in a position separated from the recording medium; and
wherein the side wall of the base comprises a third portion located adjacent to the ramp load mechanism and a third projecting portion projecting outwardly from the third portion and located outward of the side wall,
wherein the side plate of the cover include a third opening in which the third projecting portion is located.

10. The disk drive of claim 9, wherein a width of the third opening in a longitudinal direction of the side plate is set equal to or less than 20 mm.

11. The disk drive of claim 1, wherein the recording medium is a magnetic disk having a diameter of 2.5 inches.

12. A disk drive comprising:
a base comprising a bottom wall and a side wall provided along a peripheral edge portion of the bottom wall, the side wall including a pair of long side walls and a pair of short side walls;
a cover comprising a top plate located opposite to the bottom wall, and a side plate provided along a peripheral edge of the top plate, the side plate including a pair of long side plates and a pair of short side plates, the top plate being screwed on an upper end face of the side wall of the base, the long side walls and the short side walls being located opposite to an outer surface of the side wall of the base;
a sealing member held between the top plate of the cover and the upper end face of the side wall; and
a recording medium rotatably provided at the bottom wall of the base,
wherein the pair of long side plates of the cover include respective openings,
in positions of the openings, the pair of long side walls of the base include respective projecting portions outwardly projecting and located outward of the side wall, and a distance between outer surfaces of the projecting portion is greater than a width of the cover.

13. The disk drive of claim 12, wherein the openings of the long side plates are provided on a straight line extending through a center of the recording medium and parallel to the short side walls, and the projecting portions of the long side walls project outwardly from the long side walls through the openings.

14. The disk drive of claim 12, wherein width of the openings in longitudinal directions of the long side plates set equal to or less than 20 mm.

15. A disk drive comprising:
a base comprising a bottom wall and a side wall provided along a peripheral edge portion of the bottom wall,
a cover comprising a top plate fixed to the side wall, a side plate provided along a peripheral edge of the top plate and opposing to an outer surface of the side wall, and an opening formed in the side plate;
a sealing member held between the top plate of the cover and an upper end face of the side wall; and
a recording medium rotatably provided at the bottom wall,
wherein the side wall of the base comprises a projecting portion projecting from the side wall outward of the side wall and located in the opening the side plate.
